(19) United States
(12) Patent Application Publication
(10) Pub. No.: US 2005/0082248 A1
(43) Pub. Date: Apr. 21, 2005

(54) Elastic membrane container closure

(76) Inventors: Omar Al-Jadda, Norwalk, OH (US); Aadel Al-Jadda, Norwalk, OH (US)

Correspondence Address: OMAR AL-JADDA, 115 SYCAMORE DR., NORWALK, OH, 44857, US

(21) Appl. No.: 10/689,117

(22) Filed: Oct. 21, 2003

(51) Int. Cl. B67D 3/00; B65D 47/00

(52) U.S. Cl. 215/313; 222/544

(57) ABSTRACT

The invention relates to a closure of the iris diaphragm type engaging a neck portion of a container. The closure includes a thin, flexible elastic tubular member having one end connected to a rigid mobile tubular member and the other end connected to the fixed neck portion of the container. Two male protrusions on the inner surface of the mobile rigid tubular member engage female notches on the fixed outer surface of the container neck such that when the mobile member is rotated, it causes the elastic tube to twist and fold upon itself in an iris-diaphragm fashion thereby rendering a fluid, solid and light impermeable seal at the iris. The mobile member can be rotated variably thereby reducing the matter flow through the center of the container.

### CROSS-REFERENCE TO RELATED APPLICATIONS

Not Applicable

### BACKGROUND OF THE INVENTION

1. Field of the Invention

The invention relates to closures in general, and more specifically to container closures comprising of flexible, matter impermeable elastic seals that open and close in an iris diaphragm fashion.

2. Description of Related Art

In addition it is desirable to provide a container closure that opens and closes without the burden of a loose detachable member such as a screw-on bottle cap, a cork or a pop-open closure. These two-piece separated closures provide a number of problems. First, in the case of most liquid containers, they are often small and can easily be lost. Secondly, they provide an unnecessary choking hazard for young children when not disposed of properly. Thirdly, they can easily be littered and provide an environmental hazard. Fourthly, in the case of a corked, carbonated liquid container, such as a champagne bottle, they can become harmfull projectiles. And lastly, it can be inconvenient and cumbersome for the consumer to open a container, set down or hold the container top closure and after using the contents, reapply the container top closure and close the container. For example, the ratchet cap described in U.S. Pat. No. 5,143,237 requires a cap that must be removed in order to allow fluid to flow to or from the container, and cannot be variably changed.

Furthermore, flip-top closures as described in U.S. Pat. No. 5,992,659 requires cumbersome manual labor to open and close. Consumers, particularly consumers with weak hands due to arthritis or other ailments, may have trouble opening flip-top closures when they apply a great force to a small lip on the closure, which may cause undue stress to the hands or fingers.

### BRIEF SUMMARY OF THE INVENTION

It is an object of the invention to provide an iris type closure that involves simple rotation to open and close, and contains no detachable moving parts. It is another object to provide a closure that is water, liquid, and light impermeable and is durable.

The present invention is for a container closure comprising of a thin, elastic cylinder affixed at one end permanently to the neck of the container, and at the other end connected permanently to the top of the mobile rigid cylindrical member. When the mobile member is turned with respect to the container neck, the elastic cylinder tends to twist and fold upon itself creating a variably controllable opening, which may be closed completely.

The present invention also includes a notch and track system wherein two male protrusions opposite each other on the inner surface of the mobile member engage a recessed track with female notches. Applying force to the outer surface of the mobile member on a line perpendicular to the line containing both male protrusions causes the protrusions to disengage the track allowing for easier opening and closing.

### BRIEF DESCPRITION OF THE SEVERAL VIEWS OF THE DRAWING

FIG. 1 is a cross-sectional side view of the present invention with the elastic membrane affixed to the mobile rigid tubular member and the fixed container neck. The elastic membrane is both open and untwisted.

FIG. 2 is cross section of the present invention at line 42 of FIG. 1 showing the notch and track system with the elastic membrane completely closed and twisted.

FIG. 3 is a prospective view of cap 120 of FIG. 1.

FIG. 4 is a prospective view of neck body 240 of FIG. 1.

### DETAILED DESCRIPTION OF THE INVENTION

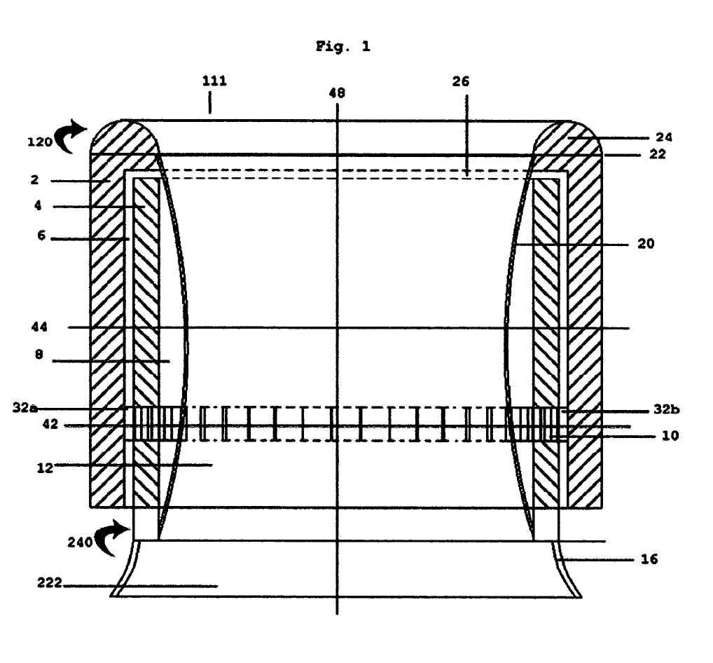

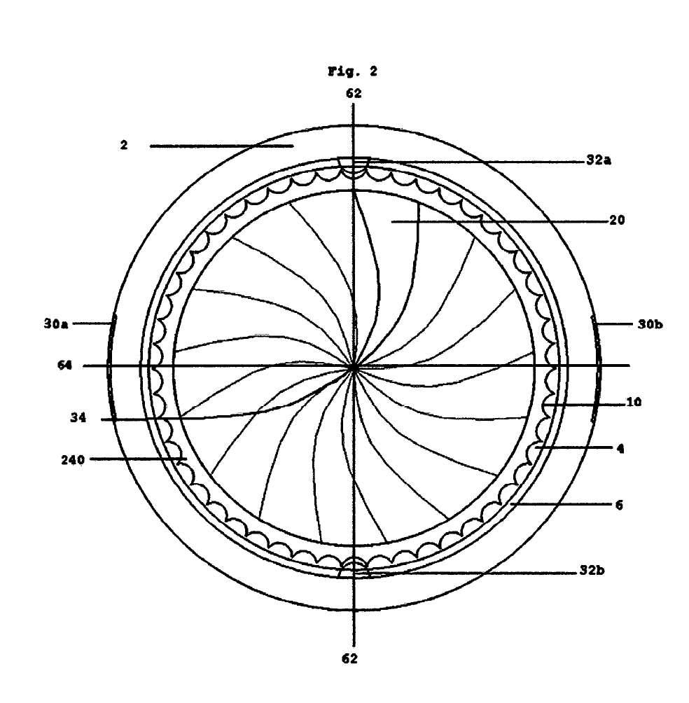

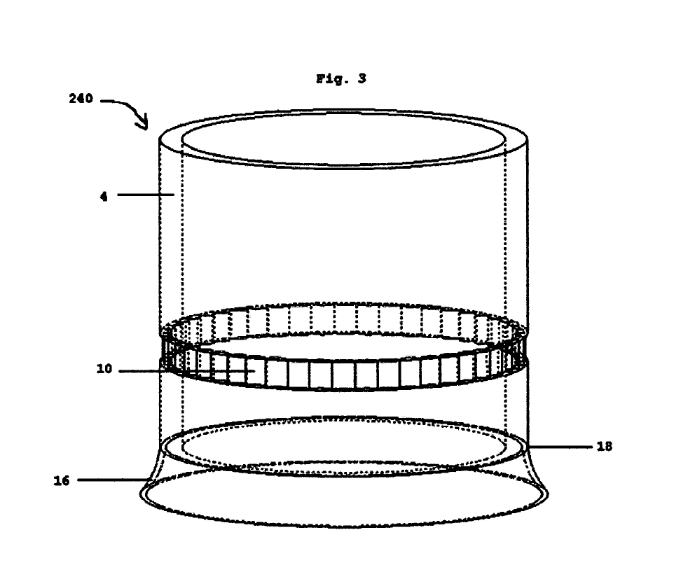

A tubular mobile rigid cap containing members 2, 24, 32a, and 32b of the closure shown in a cross sectional side view in FIG. 1 and containing members 2, 30a, 30b, 32a, and 32b of FIG. 2, is identified generally by reference character 120 and is shown in perspective in FIG. 3. The tubular elastic membrane 20 is affixed to cap 120 at junction 22. Cap lip 24 and the body of the cap 2 compress the elastic membrane 20 thereby causing junction 22. This junction can be easily manufactured via heat treatment, thermal setting, or adhesives.

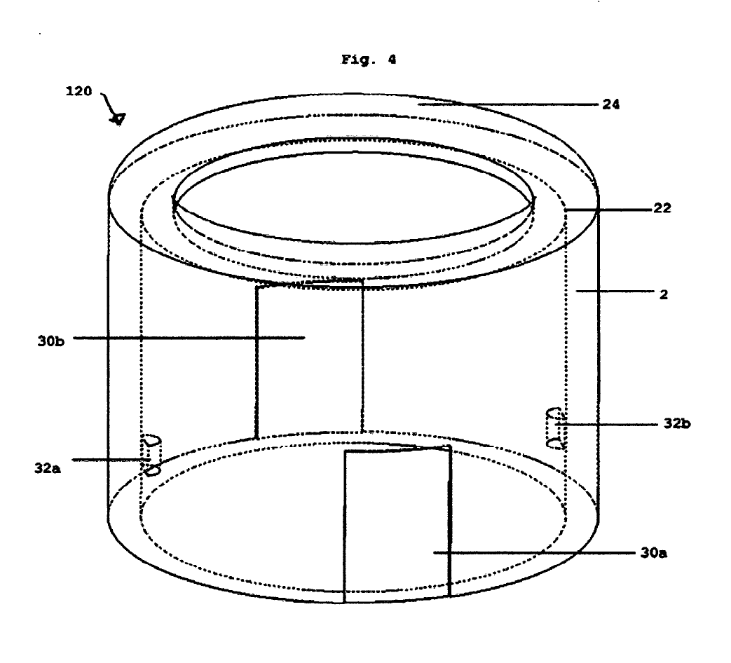

Elastic membrane 20 is compressed at the lower end between the fixed neck portion 4 of the closure and the container 16, at junction 18, similar to junction 22. Container 16 can be a fluid or solid container, pill bottle, or the like. Recessed semicircular notches 10, shown in FIG. 1 and FIG. 2, project inwardly into fixed neck portion 4 and the container 16 creating junction 18, comprises neck body 240 and is shown in prospective in FIG. 4.

Cap 120 and neck body 240 engage via the two male protrusions 32a and 32b along notched track 10. Rigid member 2 is slightly separated from rigid member 4 creating gaps 6 and 26. These gaps prevent damaging friction to bodies 120 and 240. Furthermore, gaps 6 and 26 reduce the force required to turn body 120 with respect to 240. The user has two options when opening or closing the closure. By squeezing tabs 30a and 30b on the other wall of cap 120 the user will disengage the two male protrusions 32a and 32b from the notches of track 10. Rotation thereafter allows for male protrusions 32a and 32b to move along the track 10 but without engaging the notches thereby reducing frictional force required to twist. In this case, the user will encounter only force of the elastic member 20 when closing the closure. There is, however, a negligible frictional interaction between a small segment of the surfaces of rigid bodies 2 and 4 when tabs 30a and 30b are suppressed. This interaction is required to prevent male protrusions 32a and 32b from traveling outside of track 10 (yet still disengaging it from the notches). The user may also choose not to disengage male protrusions 32a and 32b from the notches of track 10 and may choose instead to simple twist cap 120 and allow male protrusions 32a and 32b to continually reengage and lock every notch along track 10. The said male protrusions will stay engaged with the said notches unless manually disengaged. In this case, the user must overcome the force of the elastic membrane and the force of friction between male protrusions 32a and 32b with track 10. It is thereby assumed that the force of the elastic membrane 20 is not great enough to overcome the friction between the male protrusions 32a and 32b and the notched track 10, therefore locking cap 120 at any desired position.

The elastic membrane 20 forms an iris-diaphragm closure when cap 120 is rotated with respect to neck body 240. When closed, reverse rotation of 120 causes the closure to open. The iris 34 (FIG. 2) is formed when cap 120 is rotated at least three hundred sixty degrees. Said iris is formed at the intersection of line 44 and 46 in FIG. 1 and the intersection of line 62 and 64 in FIG. 2. When fully closed, the iris-diaphragm seal formed along line 44 separates the outer environment 111 from the environment inside the container 222 rendering the closure impermeable to any gas, liquid, solid, or light. Gaps 8, 6, and 26 are continuous with environment 111, although the matter travels from environment 222 into 111. The variable permeably of elastic membrane 20 depends upon the amount cap 120 is twisted with respect to neck body 240. The amount of permeability in the present figure representation contains 50 notches inside notched track 10 allowing for adjustment at 7.5 degree intervals. The number of notches and degrees of separation can be changed, hence altering the angular degree intervals and the course or fineness of the variable of permeability.

The elastic membrane 20 has a relative thickness and viscoelastic characteristic. Under operation the elastic membrane 20 functions in the elastic region of denaturization and does not stretch plastically. Hence elastic membrane 20 relieves from stress into its original shape. Such properties are found in polymers containing a mainly crosslinked, ordered lattice orientation as seen in nature and synthetic rubber such as latex, neoprene, polystyrene, polyethylene, and the like. The elastic membrane 20 can also be processed opaque through polymer pigmentation, preventing the passage of light. The thickness of said membrane can additionally be alter to fulfill the capacity of light diffraction. The present invention identifies the elastic membrane 20 as generically a membrane presenting rubber properties and reflects light.

As will be apparent to those skilled in the art, the present invention will have many applications and can be adapted to varying dimensions and materials for construction. Applications of the present invention include any container used for storage, or frequent use of any fluid or solid. The advantages of the present invention include the ability to open and close a container with minimal effort without removing a lid, cap, or top of any kind. However, the present invention can be constructed inexpensively with readily available materials such as plastics, polymers, and synthetic or natural rubbers. Although the invention has been described specifically, it is evident that many alternatives, modifications, and variations will be apparent to those skilled in the art in light of the foregoing description. Accordingly, it is intended to embrace all such alternatives, modifications and variations that fall within the broad scope of the appended claims.

1. A container closure comprising,
a mobile cylindrical cap having an opening,
a neck portion of said container,
a tubular elastic membrane having one end connected to the said cap and the other end connected to said neck,
means for rotating said cap with respect to said neck.

2. A closure as claimed in claim 1 wherein said cap and said neck interact wherein male protrusions from said cap engage semicircular notches arranged circularly about said neck therein creating a locking mechanism when said cap is rotated with respect to said neck and said tubular elastic membrane twists and folds upon itself in an iris-diaphragm fashion thereby creating a seal.

3. A closure as claimed in any of claims 1 or 2 wherein the seal formed is fluid, solid, and light impermeable.
